(19) United States
(12) Patent Application Publication
(10) Pub. No.: US 2013/0135587 A1
(43) Pub. Date: May 30, 2013

(54) MOTION PICTURE FILM

(71) Applicants: Antonio D'Arienzo, Roma (IT); Pietro Pacitto, Sant'Ella Flumerapido (IT); Alessandro Adamo, Roma (IT); Dario Marzeglia, Roma (IT)

(72) Inventors: Antonio D'Arienzo, Roma (IT); Pietro Pacitto, Sant'Ella Flumerapido (IT); Alessandro Adamo, Roma (IT); Dario Marzeglia, Roma (IT)

(73) Assignee: THOMSON LICENSING, Issy de Moulineaux (FR)

(21) Appl. No.: 13/816,246

(22) PCT Filed: Aug. 9, 2011
(86) PCT No.: PCT/IB11/01836

§ 371 Date: Feb. 11, 2013

(30) Foreign Application Priority Data
Aug. 16, 2010 (IT) MI2010A001556

(51) Int. Cl. G03B 21/64; G03B 31/02; G03B 31/00

(52) U.S. Cl. CPC G03B 21/64; G03B 31/00; G03B 31/02
USPC 352/5; 352/82; 352/40; 352/37; 352/27; 352/38

(57) ABSTRACT

A motion picture film includes a plurality of frames, with each frame formed of a first and second sub-frames. Each of the first and second sub-frames encompasses an image of a separate one of first and second sequences of successive images independent of each other. The first and second sequences of images typically undergo display one prior to the other, by projecting the film twice in succession, the first time to display the images in the first sequence, the second time to display the images in the second sequence. The film also carries two separate sets of sound tracks, each corresponding to separate one of the first and second sequences of successive images for separate playback.

### CROSS-REFERENCE TO RELATED APPLICATIONS

This application claims the benefit of the filing date of Italian Patent Appln. No. MI2010A001555, filed on Aug. 16, 2010, titled “MOTION PICTURE FILM”, the contents of which are hereby incorporated by reference in their entirety for all purposes.

### TECHNICAL FIELD

This invention relates to motion picture film, and method of manufacturer thereof.

### BACKGROUND ART

Presently, motion picture films distributed for theatrical exhibition comprise a collection of reels of 35 mm film. The Society of Motion Picture and Television Engineers (SMPTE) has standardized the dimensions for such films as follows:
16 frames per foot (long pitch));
24 frames per second ;
vertical pull-down; and
4 perforations per frame

The SMPTE standard specifies that each frame occupies an area approximately 25 mm in width and 19 mm in height, the frame height corresponding to distance occupied by four (4) film perforations. For non-theatrical films, the frames can have reduced height corresponding to three (3) perforations or even two (2) perforations.

A typical feature length motion picture will run as much as two hours or more. At a speed of 24 frames per second, a two-hour movie comprises about 3350 meters (10,800 feet) of film. A typical film reel holds between 500-600 meters of film, so a feature length motion picture film for theatrical release requires 6-7 reels. A large motion picture studio might produce as many as ten major motion picture films for theatrical release each year. Within the United States alone, there are approximately four thousand screens, with at least that many screens existing in the rest of the world. Thus, distributing a feature-length motion picture for world-wide release entails shipping a large number of film reels, a considerable undertaking.

A growing number of theater screens have converted to digital cinema, thus obviating the need to distribute reels of film. Instead, content distribution occurs by satellite or by hard disk. , The vast majority of theater screens have not yet converted to digital cinema, so a movie studio seeking wide release of a feature length motion picture film must still arrange for the manufacture and distribution of film in reels

Thus, a need exists to reduce the resources required to distribute motion picture film in reels.

### BRIEF SUMMARY OF THE INVENTION

Briefly, in accordance with a preferred embodiment of the present principles, a motion picture film comprises plurality of frames, each comprised of first and second sub-frames. The first and second sub-frames encompass images of first and second sequences of successive images, respectively, that differ from each other.

### BRIEF DESCRIPTION OF THE DRAWINGS

FIG. 1 depicts a length of motion picture film in accordance with an illustrative embodiment of the present principles; and

FIG. 2 depicts in flow chart form the steps of a process for creating the motion picture film of FIG. 1

### DETAILED DESCRIPTION

Typical motion picture films comprise a plurality of frames, each frame encompassing an image within a sequence of successive images. Projecting the frames one after the other in rapid succession (24 frames per second), allows a viewer to observe objects in motion, giving rise to the term “motion picture” film. A typical two-hour feature length motion picture film contains as many as 120,000-140,000 frames, consuming about 3350 meters (10,800 feet) of film. Reducing the amount of film associated with a feature length presentation without reducing the total number of frames would save costs and reduce distribution overhead.

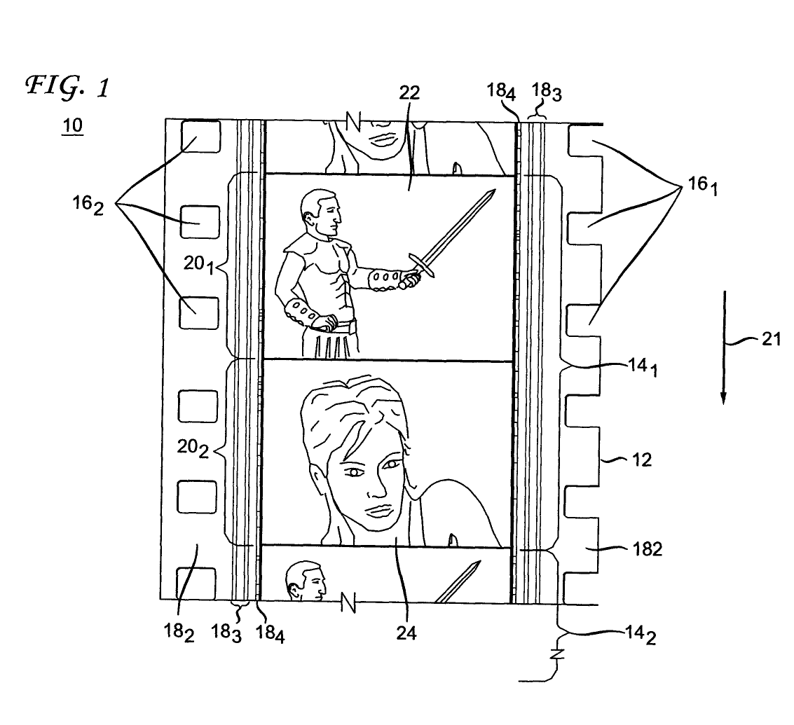

FIG. 1 depicts a portion of a motion picture film 10 in accordance with a preferred embodiment of the present principles which offer reduced film length without reducing the number of frames. The film 10 comprises a film base 12 having a plurality of frames, with only frame 14₁ and a portion of frame 14₂ depicted in FIG. 1. First and second sets of perforations 16₁ and 16₂ run the length of the film base 12 outside the edges of the frames. In practice, each frame, such as frame 14₁ in FIG. 1 has a height corresponding to the length occupied by four of the perforations, giving rise to the term “4 Perf frame”. In addition to the frames which carry image information as discussed hereinafter, the film stock 12 also carries one or more soundtracks. As illustrated in FIG. 1, the film stock carries a set of sound tracks, including Dolby® digital audio sound track 18₂, analog sound track 18₃ and DTS sound track 18₄.

Previously, each frame of a motion picture film encompassed a single image of sequence of successive images. In contrast, each frame of the motion picture film 10 of the present principles comprises first and second sub-frames 20₁ and 20₂ (mirrored image), typically arranged with the first sub-frame lying above the second sub-frame, with respect to the direction of film motion, as evidenced by arrow 21. The first and second sub-frames 20₁ and 20₂ of a given frame, say frame 14₁ contain images 22 and 24, respectively, of first and second sequences of successive images that are independent of each other. The images of the first sequence lie out of sequence with those of second sequence. As will become better understood hereinafter, the images of the first sequence of successive images undergo display in succession at a different time, typically prior to successive display of the images of the second sequence of successive images.

As shown in FIG. 1, successive images of the first and second sequences of successive images are interleaved among the frames of the film 10. For instance, the first-sub frame 20₁ of a first frame, say frame 14₁, encompasses a first image of the first sequence of successive images, whereas the first sub-frame of a second film frame, say frame 14₂ encompasses the next image in the first sequence, and so on. In a similar manner, the second-sub frame 20₁ of the frame 14₁ encompasses a first image of the second sequence of successive images, whereas the second-sub frame of the second film frame 14₂ will contain the next image in the second sequence, and so on.

As discussed, the first and second sequences of successive images differ in terms of their display order, such that images of the first sequence undergo in succession prior to the successive display of the images of the second sequence. Thus, to display the images encompassed by the first and second sub-frames, the film 10 undergoes projection twice. During a first projection of the film 10, the images of the first sequence of successive images will appear in succession. During a second projection of the film 10, the images of the second sequence of successive images will appear in succession. In order to display the second sequence of successive images the reels must be rewound and loaded with emulsion facing the projector lens. To prevent display of both the first and second sub-frames at the same time, the film projector (not shown) will require modification of its aperture plate so that the light from the projector illuminates only one of the two sub-frames of each frame as the film runs through the projector.

Creating the film 10 so each film frame encompasses images of the first and second sequences of successive images requires that the film have two independent sets of audio tracks.

The first set of audio tracks (typically comprising audio tracks 18₂-18₄) correspond to the first sequence of successive images, whereas the second set of audio tracks correspond to the second sequence of successive images (. Given that the first and second sequences undergo display at separate times, the first and second sets of audio tracks corresponding are thus independent of each other and carry separate audio information. In this regard, existing projectors only play back the audio tracks at the left the frame.

Several techniques exist to provide the film 10 with two sets of sound tracks corresponding to the first and second sequences of successive images. For example, each side of the film 10 carries a separate one of the two sets of sound tracks. To play the relevant audio, a projectionist would load the film 10 in the projector with the emulsion facing the projector lamp the first time to display the first sequence of successive images 20₁ and with the emulsion facing the projector lens to display the second sequence of successive images 20₂ so that the appropriate set of sound tracks appear to the right of the projected frame.

A second option exists which avoids the need to rewind the reel at the end of the projection of the top frame. During manufacture of the film 10, the image occupying the second sub-frame 20₂ with each frame, say frame 14₁ would get printed upside down and in reverse motion order compared to image in the first sub-frame 20₁. This technique allows the projectionist to load the film reel from the tail end instead of the head end, thus saving time. The two halves get combined together and rendered in single 4 perforation frame. This approach, for both options, affords the advantage of obviating the need for mechanical modifications during the projection operation and only minor changes with regard to the optical path.

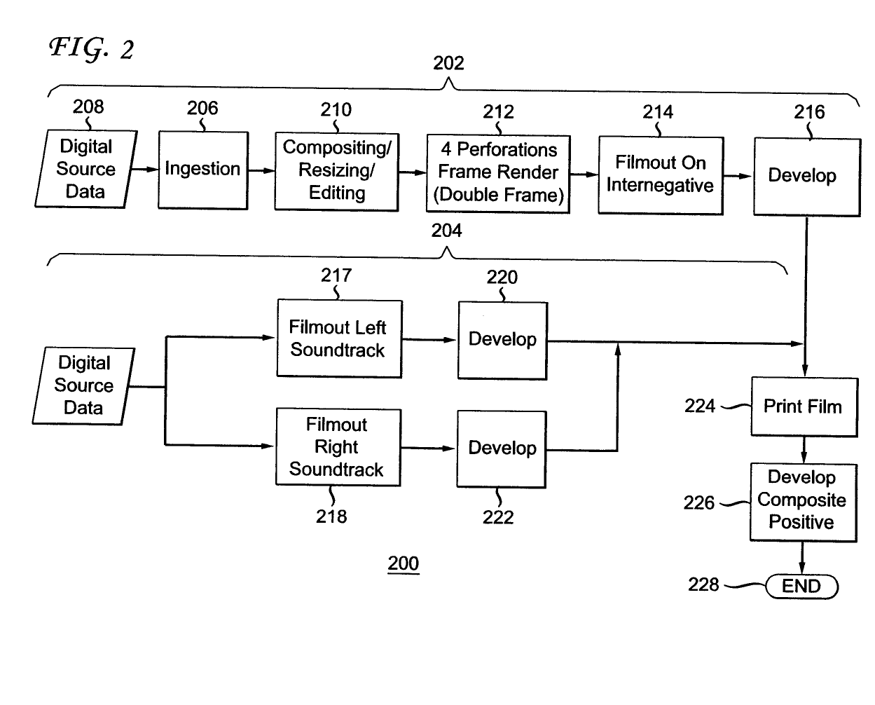

FIG. 2 depicts in flow chart a method 200 for producing the film 10 of FIG. 1 with its interleaved images of the first and second sequences of successive images and its dual sound track. The method 200 includes a first set of steps 202 associated with image processing and a second set of steps 204 associated sound track creation. Execution of the sets of steps 202 and 204 can occur at the same or at different times. The first step 206 within the set of steps 202 associated with image process comprises ingestion (e.g., receipt and storage) of digital image data from a digital image source 208, for example a film scanner. Following ingestion, the image data undergoes compositing, resizing and/or editing during step 210. Following step 210, step 212 occurs during which frame rendering occurs to create the sub-frames 20₁ and 20₂ of FIG. 1. so the first and second sub-frames encompass images of the first and second sequences of successive images, respectively, arranged in the manner described above. Step 214 occurs after step 212 during which time film out occurs to create an internegative print which undergoes developing during step 216.

The set of steps 204 associated with creation of the two independent sound tracks commences with steps 217 and 218 during which film-out of the left and right sound tracks occurs, respectively. (Steps 217 and 218 can occur at the same or different times.) Steps 220 and 222 follow steps 217 and 218, respectively, during which development of left and right sound tracks occurs, respectively.

After completion of the sets of steps 202 and 204 associated with image processing and sound track creation, respectively, printing of the film occurs during step 224 using a printing machine (not shown) having two sets of sound heads, each creating a separate one of the two independent sound tracks on the film. The film printed during step 224 undergoes developing during step 226 to create a composite positive for theatrical release. The process ends at step 228.

The foregoing describes a motion picture film, and a method of manufacture, which yields a reduced film length with no sacrifice in the number of film frames.

1. A motion picture film having a plurality of frames, each frame comprising:
a first sub-frame occupying a first portion of the frame, the first sub-frame encompassing an image of a first sequence of successive images;
a second sub-frame occupying a second portion of the frame, the second sub-frame encompassing an image of a second sequence of successive images independent of the first sequence of successive images;
wherein the image of the second sequence of successive images encompassed the second-sub frame of a frame has an orientation upside down and in reverse motion order relative to the image of the first sequence of successive images encompassed by the first sub-frame of said frame.

2. The motion picture film according to claim 1 further including first and second independent sound track sets associated with the first and second sequences of successive images.

3. The motion picture film according to claim 1 wherein the first and second sound track sets reside on opposite sides of the film.

4. The motion picture film according to claim 2 wherein the first and second sets of sound tracks include digital and analog sound tracks.

5. The motion picture film according to claim 1 wherein the image of the second sequence of successive images encompassed the second-sub frame of a mirrored picture

6. A method of exhibiting a motion film having a plurality of frames, each frame having first and second sub-frames occupying first and second portions of the frame, respectively, the first sub-frame and second sub-frames encompassing images of first and second sequences of successive images, respectively, with the first and second sequences independent of each other, the method, wherein the image of the second sequence of successive images encompassed the second-sub frame of a frame has an orientation upside down and in reverse motion order relative to the image of the first sequence of successive images encompassed by the first sub-frame of said frame, comprising the steps of :
projecting the film a first time from a start end to a tail end. to only display in sequence images of the first sequence of successive images; and
projecting the film a second time from the tail end to the start end with film emulsion upside down to only display images of the first second sequence of successive images.

7. The method according to claim 6 further comprising the steps of:
playing back a first sound track during the first projecting of the film; and
playing back a second sound track, independent of the first sound track, during the first projecting of the film.

8. A method of manufacturing a motion picture film having a plurality of frames, the method
establishing with each frame an image of each of first and second sequences of successive images, the first and second sequences independent of each other;
wherein the images of first and second sequences of images are arranged for display at different intervals; and
wherein the image of the second sequence of successive images encompassed the second-sub frame of a frame has an orientation upside down and in reverse motion order relative to the image of the first sequence of successive images encompassed by the first sub-frame of said frame.

9. The method according to claim 8 further comprising the step of forming on the film first and second sound track sets associated with the first and second sequences of images.

10. The method according to claim 9 wherein the first and second sound track sets reside on opposite sides of the film.

11. The motion picture film according to claim 10 wherein the first and second sets of sound tracks include digital and analog sound tracks.
